(19) United States
(12) Patent Application Publication
(10) Pub. No.: US 2022/0278764 A1
(43) Pub. Date: Sep. 1, 2022

(54) PROGRAMMABLE PHOTONIC SWITCH MODES

(71) Applicant: Sterlite Technologies Limited, Gurgaon (IN)

(72) Inventors: Puneet Kumar Agarwal, Gurgaon (IN); Vishnu Krishna, Gurgaon (IN); Koutuk Consul, Gurgaon (IN)

(21) Appl. No.: 17/620,685

(22) PCT Filed: Jul. 29, 2020
(86) PCT No.: PCT/IN2020/050665

§ 371 Date: Dec. 18, 2021

(30) Foreign Application Priority Data
Jul. 29, 2019 (IN) 2019 21030560

(51) Int. Cl. H04J 14/02

(52) U.S. Cl. CPC H04J 14/0212; H04J 14/0268; H04J 2203/005; H04J 2203/0055

(57) ABSTRACT

The present disclosure provides a method for providing a white box transponder (132). The method includes a step of receiving the plurality of user inputs (104) from an orchestrator (102) at a programmable photonic switch mode system (108). The method includes another step of receiving the real-time data from an optical line system (122). The method includes yet another step of computing a run-time mode of operation based on the plurality of user inputs (104), the real-time data from the optical line system (122), a complete path computation information, and the network dimensioning data with facilitation of the programmable photonic switch mode application (110). The complete path computation information is received from a path computation engine (120). The method includes yet another step of sending the computed run-time mode of operation to the white box transponder (132) for dynamically configuring the white box transponder (132).

### TECHNICAL FIELD

The present disclosure relates to the field of software defined networking. More particularly, the present disclosure relates to architecture of programmable photonic switch mode. The present application is based on, and claims priority from an Indian Application Number 201921030560 filed on 29 Jul. 2019, the disclosure of which is hereby incorporated by reference herein.

### BACKGROUND

Network operators needs open and programmable dense wavelength division multiplexing (DWDM) system that provides flexibility and automation to configure network demands seamlessly across operator's network. In addition, network configuration is becoming a critical requirement for operators to match pace with growing bandwidth demand due to complexity of optical equipment feature set and optical fiber impairments. Further, there is a requirement to follow a standard solution to overcome the limitations of optical impairments across multi-vendor equipment. Furthermore, the standard solution must be followed across the optical components. Moreover, the standard solution should support standard protocol to exchange configurationally and operational parameters.

In light of the above stated discussion, there is need to provide user a flexibility, through which the desired optical parameters for a service demand can be configured in a single step. The said value can be derived by setting up a programmable switch mode that includes list of the right set of optical parameters that needs to be configured on an optical module.

### OBJECT OF THE DISCLOSURE

A primary object of the present disclosure is to provide a programmable photonic switch mode application to improve network performance and quality of transmission parameters.

### SUMMARY

In an aspect, the present disclosure provides a programmable photonic switch mode system for providing real-time dynamic configurations at a white box transponder. The programmable photonic switch mode system includes a programmable photonic switch mode application. The programmable photonic switch mode application receives a plurality of user inputs from a user with facilitation of an orchestrator. The programmable photonic switch mode system includes a network dimensioning application. The network dimensioning application provides a network dimensioning data to the programmable photonic switch mode system. The programmable photonic switch mode system receives real-time data from an optical line system. The programmable photonic switch mode system is associated with an SDN controller. The programmable photonic switch mode system performs computation of run-time mode of operation.

The SDN controller may include a yang store and a path computation engine. The path computation engine provides a complete path computation information to the programmable photonic switch mode system. The programmable photonic switch mode system computes the run-time mode of operation based on the plurality of user inputs, real-time data received from the optical line system, the complete path computation information, and the network dimensioning data.

The programmable photonic switch mode system may send the computed run time mode of operation to the white box transponder for dynamically configuring the white box transponder.

The plurality of user inputs may include one or more parameters. The one or more parameters includes at least one of bitrate, protection type, hardware redundancy, path diversity, types of incoming traffic, maximum allowed restoration time, user service requirements and required traffic SLAs.

The plurality of user inputs may include one or more traffic profile. The traffic profile may include end node details, type of service, start date, end date and time of service, maximum allowed service latency, bandwidth details, priority type and service level agreement of the user.

The plurality of user inputs may include bitrate, protection type, hardware redundancy, path diversity, types of incoming traffic, and maximum allowed restoration time.

The network dimensioning data corresponds to link design, BW planning, Lambda planning.

The programmable photonic switch mode system may auto-tune the white box transponder with one or more device parameters. The one or more device parameters include channel bandwidth, channel spacing, channel lambda information, channel modulation, channel power, and forward error correction (FEC) configuration. The one or more device parameters includes differential encoder (DE) configuration, current bit error ratio (BER), chromatic dispersion (CD), polarization mode dispersion (PMD) and current channel optical signal to noise ratio (OSNR).

The mode of operation corresponds to a collection of photonic and optical network wide-ranging feature sets values.

The optical line system may include ROADM (reconfigurable optical add-drop multiplexer), wavelength selective switch (WSS), multiplexing demultiplexing unit (MDU), amplifiers, variable optical attenuator (VOA) and in-line amplifier (ILA) nodes.

In another aspect, the present disclosure provides a method for providing a white box transponder using the programmable photonic switch mode system. The method includes a first step of receiving the plurality of user inputs from a user with facilitation of an orchestrator. The method includes a second step of receiving the real-time data from the optical line system. The method includes a third step of computing a run-time mode of operation based on the plurality of user inputs, the real-time data from the optical line system, a complete path computation information, and the network dimensioning data with facilitation of the programmable photonic switch mode application. The complete path computation information is received from a path computation engine. The network dimensioning data is received from a network dimensioning application. The method includes a fourth step of sending the computed run-time mode of operation to the white box transponder for dynamically configuring the white box transponder.

The method may include yet another step of receiving a real-time frequency, power, modulation (fpm) configuration of the white box transponder from at least one of: the white box transponder or from a database storing fpm configuration data of the white box transponder. The computed mode of operation is configured to dynamically tune the white box transponder, based on the received real-time fpm configuration of the white box transponder.

The method may perform switching of the mode of operation during run-time, based on change in at least one of: the plurality of user inputs, the real-time data from the optical line system, the complete path computation information, the network dimensioning data, and fpm configuration of the white box transponder.

The method may include providing a plurality of read only (RO) optical parameters with toggling range from to a QoTd script running at the transponder. The QoTd script enables dynamic configuration of the white box transponder and the optical network feature set as per the plurality of read only (RO) optical parameter

### STATEMENT OF THE DISCLOSURE

The present disclosure provides a programmable photonic switch mode system for providing real-time dynamic configurations at a white box transponder. The programmable photonic switch mode system includes a programmable photonic switch mode application. The programmable photonic switch mode application receives a plurality of user inputs from a user with facilitation of an orchestrator. The programmable photonic switch mode system includes a network dimensioning application. The network dimensioning application provides a network dimensioning data to the programmable photonic switch mode system. The programmable photonic switch mode system receives real-time data from an optical line system. The programmable photonic switch mode system is associated with an SDN controller. The programmable photonic switch mode system performs computation of run-time mode of operation.

### BRIEF DESCRIPTION OF FIGURES

Having thus described the disclosure in general terms, reference will now be made to the accompanying figures, wherein:

FIG. 1 illustrates an interactive computing environment for providing real-time dynamic configurations at white box transponder;

FIG. 2 illustrates a flow chart depicting a method for providing real-time dynamic configurations at white box transponder device;

FIG. 3 illustrates a state machine flow diagram for modes of operation;

FIG. 4 illustrates an overview of a state machine flow diagram for QoTd script; and

FIG. 5 illustrates a block diagram of a communication device.

It should be noted that the accompanying figures are intended to present illustrations of few exemplary embodiments of the present disclosure. These figures are not intended to limit the scope of the present disclosure. It should also be noted that accompanying figures are not necessarily drawn to scale.

### DETAILED DESCRIPTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

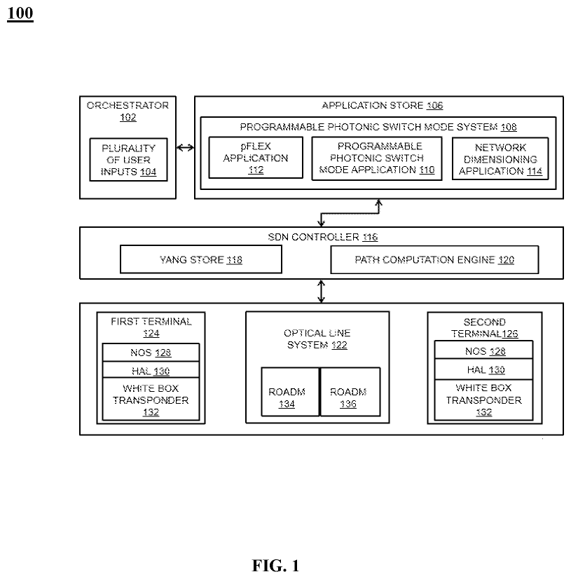

FIG. 1 illustrates an interactive computing environment 100 for providing real-time dynamic configurations at white box transponder 132. The interactive computing environment 100 includes an orchestrator 102, a plurality of user inputs 104, an application store 106, a programmable photonic switch mode system 108, a programmable photonic switch mode application 110, a pFLEX application 112, a network dimensioning application 114, a software defined networking controller 116, a yang store 118, a path computation engine 120, an optical line system 122, a first terminal 124, a second terminal 126, a network operating system 128, a hardware abstraction layer (HAL) 130, and the white box transponder 132.

The interactive computing environment 100 includes the orchestrator 102. In general, orchestrator is the means by which a process is executed, monitored and managed throughout its lifecycle. In addition, orchestration depends on series of workflows that depend on each other to enhance a production ecosystem. The orchestrator 102 includes the plurality of user inputs 104. The plurality of user inputs 104 may include one or more parameters. The one or more parameters includes at least one of bitrate, protection type, hardware redundancy, path diversity, types of incoming traffic, maximum allowed restoration time, user service requirements and required traffic SLAs. In addition, the plurality of user inputs 104 includes one or more traffic profile. The one or more traffic profile may include at least one of end node details, type of service, start date, end date and time of service, maximum allowed service latency, bandwidth details, priority type and service level agreement of the user. In an example, the user is new customer who requires a service from a vendor. In another example, the user is old customer who requires a new service from the vendor. In yet another example, the user may be any person who requires services from the vendor. The one or more traffic profile is created based on traffic criticality and preferences data of the user.

In addition, the interactive computing environment 100 includes the software defined networking controller 116 (herein after SDN controller). In general, SDN controller is an application in software defined networking architecture that manages flow control for improved network management and application performance. The SDN controller 116 provides a mechanism to grant available network media channel from a plurality of media channels to meet new demands. In addition, each of the plurality of media channels includes available network media channels and configured network media channels. Further, available network media channel is granted from the plurality of media channels to meet new demands. The SDN controller 116 ensures that configured network media channels of the plurality of media channels and nearby media channels are not impacted due to meeting new demands in terms of the one or more parameters. The one or more parameters includes but may not be limited to per channel power, power control, optical signal to noise ratio, signal to noise ratio and bit error rate.

In addition, the SDN controller 116 includes the yang store 118 and the path computation engine 120. The yang store 118 is database that includes all parameters of detected devices. In general, database is a collection of information that is organized so that it can be easily accessed, managed and updated. The yang store 118 provides all parameters required by the programmable photonic switch mode application 110. In addition, the SDN controller includes the path computation engine 120. In general, path computation engine is system component that is responsible for determining suitable route for conveying data between two nodes. The path computation engine 120 determines suitable path for signal to travel between the first terminal 124 and the second terminal 126.

The first terminal 124 and the second terminal 126 are two nodes for which network needs to be configured as per the user requirement. The first terminal 124 and the second terminal 126 includes the network operating system (NOS) 128, the hardware abstraction layer (HAL) 130 and the white box transponder 132. In general, network operating system is operating system that is designed to support workstations and personal computers that are connected on local area network. In general, hardware abstraction layer is a layer of programming that allows computer operating system to interact with optical hardware devices at abstract level. The hardware abstraction layer (HAL) 130 allows the network operating system (NOS) 128 to interact with hardware components seamlessly to configure optical parameters of devices. In addition, the hardware abstraction layer (HAL) 130 has QoTd script installed in hardware of the white box transponder 132. In general, white box transponder is wireless communication, monitoring or control device that receives and responds to an incoming signal. QoTd script is technology used to enable real time auto-tuning of white box transponder devices and optical network feature set.

The interactive computing environment 100 includes the optical line system 122. In general, optical line system is open to any white box transponder device, channel format, and the like. In addition, optical line system is endpoint hardware device in optical network. The optical line system 122 includes a ROADM 134 and a ROADM 136. The optical line system 122 may include wavelength selective switch (WSS), multiplexing demultiplexing unit (MDU), amplifiers, variable optical attenuator (VOA) and in-line amplifier (ILA) nodes. In general, reconfigurable optical add drop multiplexer (ROADM) is a device that can add, block, pass or redirect modulated infrared and visible lightbeams of various wavelengths in fiber optic network. In addition, ROADM is used in systems that use wavelength division multiplexing (WDM). The open ROADM is a suitable framework at both optical line system network and optical terminal device levels. Moreover, open configuration and open ROADM benefits in introducing optical features of interest for the quality of transmission (QoT) parameters estimates.

The interactive computing environment includes the application store 106. The application store 106 is associated with the programmable photonic switch mode system 108. The programmable photonic switch mode system includes the pFLEX application 112, the programmable photonic switch mode application 110 and the network dimensioning application 114. The application store 106 allows the user to install the programmable photonic switch mode application 110 in the programmable photonic switch mode system 108. In addition, the application store 106 allows the user to access the programmable photonic switch mode application 110. Further, the programmable photonic switch mode system 108 includes the programmable photonic switch mode application 110. The programmable photonic switch mode system 108 is associated with the orchestrator 102.

The programmable photonic switch mode system 108 receives plurality of user inputs 104 from the user with facilitation of the orchestrator 102. The programmable photonic switch mode system 108 transfers the plurality of user inputs 104 to the programmable photonic switch mode application 110. The programmable photonic switch mode application 110 receives the plurality of user inputs 104 from the programmable photonic switch mode system 108. The one or more user inputs 104 includes but may not be limited to bitrate, protection type, hardware redundancy, path diversity, types of incoming traffic, and maximum allowed restoration time. The programmable photonic switch mode application 110 is an automated application. The programmable photonic switch mode application 110 is an application that provides assured service to the user through auto tuning of the white box transponder 132 and the optical network feature set.

In addition, the programmable photonic switch mode application 110 uses parallel computing and auto control feedback mechanism to auto tune the white box transponder 132 and optical network feature set. The programmable photonic switch mode application 110 fetches new traffic profile from the orchestrator 102. The new traffic profile includes required service specifications and service level agreements specifications of the user. In an example, the new traffic profile includes bandwidth requirement, accuracy and other specifications. Further, the programmable photonic switch mode application 110 identifies a plurality of parameters that are supported on detected device. The plurality of parameters are identified on the basis of new traffic profile detected by the programmable photonic switch mode application 110. The plurality of parameters includes photonic, optical network feature set and the like. Furthermore, the programmable photonic switch mode application 110 fetches the plurality of parameters with toggle ranges from the yang store 118. Moreover, the programmable photonic switch mode application 110 classifies the plurality of parameters into configurable parameters and monitoring parameters.

The programmable photonic switch mode application 110 receives real-time data from the optical line system 122. The photonic switch mode application 110 analyses the optical line system 122 to extract real-time data associated with the available network media channel. The programmable photonic switch mode application 110 validates the real-time data received from the optical line system 122. The optical line system 122 validates availability of channels between the ROADM 134 and the ROADM 136.

The programmable photonic switch mode system 108 receives a real-time frequency, power, modulation (fpm) configuration of the white box transponder device from at least one of: the white box transponder 132 or from a database storing fpm configuration data of the white box transponder 132.

Further, the programmable photonic switch mode system 108 computes a run time mode of operation with facilitation of the programmable photonic switch mode application 110. The mode of operation is a collection of photonic and optical network features. In addition, the programmable photonic switch mode application 110 computes the mode of operation in real time to determine a suitable value that the plurality of parameters must meet requirement of the user and service level agreement. In addition, the programmable photonic switch mode application 110 computes the run-time mode of operation through pre-defined algorithm that performs validation of real time information provided by the optical line system 122. Further, the programmable photonic switch mode application 110 computes the run-time mode of operation based on the plurality of user inputs 104, a complete path computation information, the real-time data received from the optical line system 122, and a network dimensioning data. The complete path computation information is received from the path computation engine 120. In addition, the network dimensioning data is received from the network dimensioning application 114. The programmable photonic switch mode application 110 may automatically calculate the complete path and selects a particular path or a particular wavelength based on user requested bandwidth. The programmable photonic switch mode application 110 allows the user to override automatic selection of the particular path or the particular wavelength.

The programmable photonic switch mode system 108 auto-tunes the white box transponder 132 and the optical network feature set based on computing the modes of operation. The white box transponder 132 is auto-tuned using the programmable photonic switch mode application 110. The white box transponder 132 and the optical network feature set are auto-tuned based on user request and the real-time data provided by the optical line system 122. The computed mode of operation is configured to dynamically tune the white box transponder 132 based on the received real-time fpm configuration of the white box transponder 132.

The programmable photonic switch mode application 110 may be triggered based on request initiated for the network media channel by the user. The user initiates request for the network media channel through the orchestrator 102. The programmable photonic switch mode application 110 allocates the available network media channel from the plurality of network media channels to the user based on request initiated for the network media channel. The programmable photonic switch mode application 110 may searches for available ports in the white box transponder 132 based on request initiated by the user. The white box transponder 132 may support the one or more input parameters received from the user. The programmable photonic switch mode application 110 may monitor the network media channel allocated to the user. The programmable photonic switch mode application 110 monitors the network media channel allocated to the user to allow seamless switching within the modes of operation for providing non-interrupted communication to the user. The white box transponder 132 is auto-tuned with one or more device parameters. The one or more device parameters includes but may not be limited to channel bandwidth, channel spacing, channel lambda information, channel modulation, channel power, and forward error correction (FEC) configuration, wherein the one or more device parameters comprising differential encoder (DE) configuration, current bit error ratio (BER), chromatic dispersion (CD), polarization mode dispersion (PMD) and current channel optical signal to noise ratio (OSNR). In addition, the one or more device parameters include but may not be limited to frequency, power, and modulation.

The application store 106 is connected to the SDN controller 116. The application store 106 is a storage area for storing applications that run in coordination with the SDN controller 116. In an example, the application store 106 receives input from a user via the orchestrator 102 and provides required application to the SDN controller 116, for giving output signals to the white box transponder 132. The application store 106 is installed in a communication device. The communication device is associated with the user. The communication device includes but may not be limited to a smartphone, a laptop, a personal desktop, a tablet and a personal assistant. In addition, the communication device works accurately in real time. Further, the communication device includes the application store 106. The application store 106 is installed in the communication device. Further, the communication device includes the pFLEX application 112, the programmable photonic switch mode application 110 and the network dimensioning application 114. The communication device is internet enabled device that allows the user to access the programmable photonic switch mode application 110 through the application store 106. The communication device includes the network dimensioning application 114. The network dimensioning application 114 provides the network dimensioning data to the programmable photonic switch mode system 108. The network dimensioning application 114 is used for link designing, bandwidth calculation and lambda (wavelength) planning. In addition, the network dimensioning application 114 checks optical signal to noise ratio during link designing. The communication device includes the pFLEX application 112. The programmable flex grid (pFLEX) application 112 is real time dynamic flex grid provisioning application configured at the SDN controller 116. The SDN controller 116 provides a plurality of read only (RO) optical parameters with toggling range to a QoTd script. The QoTd script enables dynamic configuration of the white box transponder 132 and the optical network feature set as per the plurality of read only (RO) optical parameters provided by the SDN controller 116.

Further, the programmable photonic switch mode application 110 uses the programmable flex grid (pFlex) application 112 for computation. In addition, the programmable flex grid application 112 is used for computation of basic photonic features. Photonic features include but may not be limited to frequency, modulation and power. In addition, the programmable photonic switch mode application 110 uses network dimensioning application for link design, bandwidth and lambda planning (wavelength). Further, the programmable photonic switch mode application 110 uses the path computation engine 120 for path planning through which data need to be transmitted between the first terminal 124 and the second terminal 126. Furthermore, the programmable photonic switch mode application 110 takes inputs from the pFLEX application 112, the network dimensioning application 114 and the path computation engine 120 and calculates required values of the plurality for parameters. The programmable photonic switch mode application 110 parallelly computes and executes the modes of operation simultaneously. The programmable photonic switch mode application 110 facilitates dynamic processing.

The programmable photonic switch mode application 110 works in association with the pFLEX application 110, the network dimensioning application 114 and the path computation engine 120. The programmable photonic switch mode application 110 works in association with the pFLEX application 112 and the network dimensioning application 112. The programmable photonic switch mode application 110 works in association with the pFLEX application 112. The programmable photonic switch mode application 110 may work in association with any suitable application of the like.

The programmable photonic switch mode application 110 applies the modes of operation on device. Also, the programmable photonic switch mode application 110 classifies the plurality of parameters in a first group of parameters and a second group of parameters. The second group of parameters are handled by the programmable photonic switch mode application 110. In addition, the programmable photonic switch mode application 110 sends a first group of parameters to the QoTd script present in the hardware abstraction layer 130 of the white box transponder 132. Further, the first group of parameters with toggle limits are transferred to the QoTd script of the first terminal 124 and the second terminal 126. Furthermore, the first group of parameters are monitored and tuned as per toggle limit in the white box transponder 132 using the QoTd script. The QoTd script is used for auto tuning of optical features of the white box transponder 132 based on the first group of parameters provided by the programmable photonic switch mode application 110.

The first group of parameters includes various quality of transmission (QoT) parameters that includes but may not be limited to optical signal to noise ratio, bit error rate modulation, baud rate and forward error correction. The programmable photonic switch mode application 110 provides a read only quality of transmission (QoT) parameters with toggling ranges that needs to be monitored while configuring a read writable QoT parameters. The read only quality of transmission (QoT) parameters are used as input to configure the read writable QoT parameters. The read only QoT parameters includes but may not be limited to PD loss, signal to noise ratio per polarization, operating temperature, current optical signal to noise ratio, average bit error rate, modulator bias offset (X/I, Y/I, X/Q, Y/Q), transmitted alignment status, received alignment status, current/average differential group delay, current Q value, and current carrier frequency offset. The read writable QoT parameters includes but may not be limited to transmitted laser fine tune frequency, received laser fine tune frequency, chromatic dispersion control, cross polarization weights, cross polarization gain, variable optical attenuator target power, variable optical attenuator attenuation, pulse shaping filter, pulse shaping roll off value, received input power and transmitted output power.

QoTd script is interpreted in real time by SKRYPT interpreter that provides minimal runtime environment for execution. Moreover, QoTd script enables continuous automated change in configuration on white box transponder for gradual network tuning over a time period. Also, different QoTd script may be provisioned on the white box transponder 132 based on input from the programmable photonic switch mode application 110. Different QoTd script is provisioned on the white box transponder 132 based on input from the orchestrator 102 for high level configuration automation change. In addition, QoTd sends feedback traps to the programmable photonic switch mode application 110 when optical impairments are determined in optical channel. Further, feedback traps are forwarded for monitoring or tracking to maintain quality of transmission estimates. Furthermore, the programmable photonic switch mode application 110 switches traffic between the defined modes of operation to provide smart, seamless and congestion control structure.

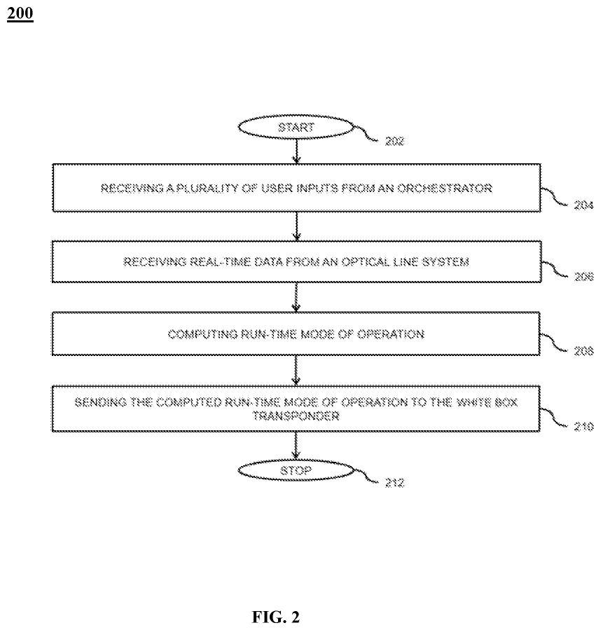

FIG. 2 illustrates a flow chart 200 depicting a method for providing real-time dynamic configurations at the white box transponder 132 using the programmable photonic switch mode system 108. The method initiates at step 202. Following step 202, at step 204, the method includes receiving the plurality of user inputs 104 from the user with facilitation of the orchestrator 102. At step 206, the method includes receiving real-time data from the optical line system 122. The optical line system 122 ROADM (reconfigurable optical add-drop multiplexer) 134, 136, wavelength selective switch (WSS), multiplexing demultiplexing unit (MDU), amplifiers, variable optical attenuator (VOA) and in-line amplifier (ILA) nodes.

At step 208, the method includes computing a run-time mode of operation. The run-time mode of operation is computed with facilitation of the programmable photonic switch mode application 110. The run-time mode of operation is computed based on the plurality of user inputs 104, the real-time data from the optical line system 122, the complete path computation information, and the network dimensioning data with facilitation of the programmable photonic switch mode application 110. The complete path computation information is received from the path computation engine 120. The network dimensioning data is received from the network dimensioning application 114. The network dimensioning data may correspond to link design, BW planning, Lambda planning. In addition, the method includes receiving a real-time frequency, power, modulation (fpm) configuration of the white box transponder 132 from at least one of: the white box transponder 132 or from a database storing fpm configuration data of the white box transponder 132 or a database storing fpm configuration data of the whit box transponder 132.

At step 210, the method includes sending the computed run-time mode of operation to the white box transponder 132 with facilitation of the programmable photonic switch mode application 110 at the programmable photonic switch mode system 108. The run-time mode of operation may correspond to the collection of photonic and optical network wide-ranging feature sets values. The computed mode of operation is configured to dynamically tune the white box transponder 132. The computed mode of operation is configured based on the received real-time fpm configuration of the white box transponder 132.

The white box transponder 132 is auto-tuned with the one or more device parameters. The one or more device parameters include channel bandwidth, channel spacing, channel lambda information, channel modulation, channel power, and forward error correction (FEC) configuration, wherein the one or more device parameters comprising differential encoder (DE) configuration, current bit error ratio (BER), chromatic dispersion (CD), polarization mode dispersion (PMD) and current channel optical signal to noise ratio (OSNR). The method performs switching of the mode of operation of the white box transponder 132 during run-time, based on change in at least one of the plurality of user inputs 104, the real-time data from the optical line system 122, the complete path computation information, the network dimensioning data, and fpm configuration of the white box transponder 132. The method includes providing a plurality of read only (RO) optical parameters with toggling range from to a QoTd script running at the white box transponder 132. The QoTd script enables dynamic configuration of the white box transponder 132 and the optical network feature set as per the plurality of read only (RO) optical parameters. The method terminates at step 212.

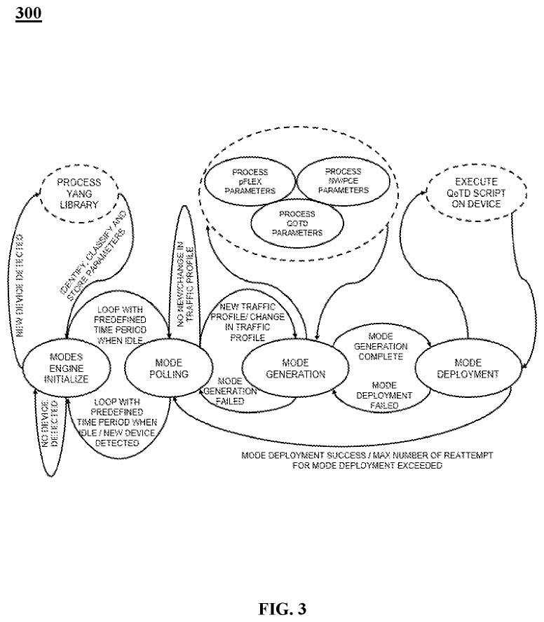

FIG. 3 illustrates a state machine flow diagram 300 for modes of operation. The state machine flow diagram 300 for the modes of operation includes a first machine state, a second machine state, a third machine state and a fourth machine state. In addition, the modes of operation includes a first machine sub-state, a second machine sub-state and a third machine sub-state. Further, the first machine state is for initializing modes engine. Furthermore, flow moves to a first machine sub-state when new device is detected in the first machine state. The first machine sub-state processes the yang store 118. In addition, the programmable photonic switch mode application 110 identifies, classifies and store various parameters during the first machine sub state.

Moreover, flow remains on the first machine state when no new device is detected. Also, states switch between each other in looped manner with predefined time period, when the system is idle (no new traffic profile or new device detected) until new traffic profile or new device is detected. In addition, flow remains on the second machine state of mode polling until new device or new traffic profile is detected. In addition, flow moves back to the first machine state when the second machine state detects new device. Further, flow moves to the third machine state if new traffic profile or change in traffic profile is detected. The third machine state for the modes of operation generates modes. Moreover, flow moves to the second machine sub-state. The second sub-state includes processing of quality of transmission (QoT) parameters, p-Flex parameters and path computation engine parameters. In addition, flow moves to the second machine state if mode generation is failed. Further, flow moves to the fourth machine state if mode generation is completed. The fourth machine state is for mode deployment. Furthermore, flow moves to the third machine sub-state if mode deployment is completed. The third machine sub-state executes the QoTd script on new detected device. In addition, flow moves to the third machine state if mode deployment is failed. Moreover, flow moves to the second machine state when mode deployment succeeds and the flow continues from the second machine state (as explained earlier). Also, flow moves to the second machine state when particular mode deployment attempt fails for a predefined number of times then flow continues from the second machine state as explained earlier.

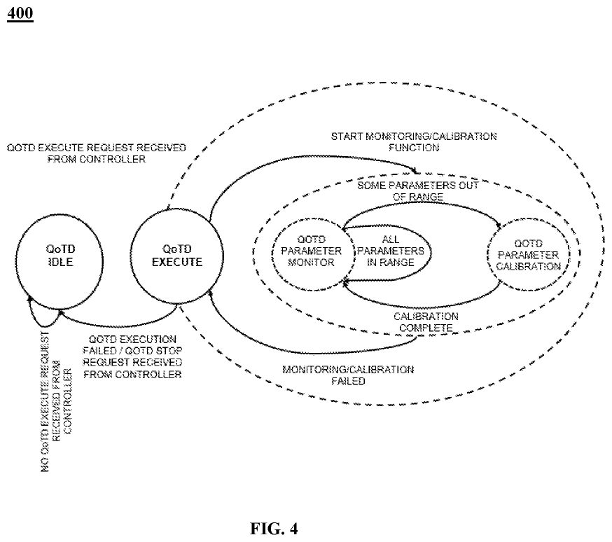

FIG. 4 illustrates an overview 400 of a state machine flow diagram for QoTd script. The state machine flow diagram for QoTd script includes a first machine state and a second machine state. In addition, the state machine flow diagram for QoTd script includes a first sub-state. The first machine state is when QoTd is idle. In addition, flow remains on the first machine state when no request is received from the programmable photonic switch mode application 110. Further, flow moves to the second machine state if the QoTd script receives request for executing QoTd script from the programmable photonic switch mode application 110. Moreover, flow moves back to the first machine states if execution of the QoTd script is failed. Also, flow moves back to the first state machine if QoTd script receives stop request from the programmable photonic switch mode application 110. Also, flow moves to the first machine sub-state to execute QoTd script. The programmable photonic switch mode application 110 starts monitoring and calibrating the quality of transmission parameters (QoT) during the first machine sub-state. In addition, QoTd script checks whether all quality of transmission (QoT) parameters are in pre-defined range. Further, QoTd script calibrates quality of transmission (QoT) parameters which are out of pre-defined range. Furthermore, QoTd script keeps on executing in real time to continuously tune the quality of transmission (QoT) parameters.

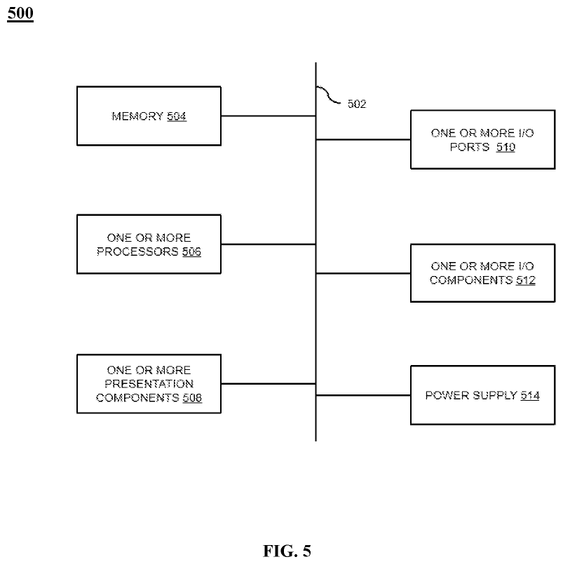

FIG. 5 illustrates a block diagram of a computing device 500. The communication device 500 includes a bus 502 that directly or indirectly couples the following devices: memory 504, one or more processors 506, one or more presentation components 508, one or more input/output (I/O) ports 510, one or more input/output components 512, and an illustrative power supply 514. The bus 502 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary communication device 500 that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

The communication device 500 typically includes a variety of computer-readable media. The computer-readable media can be any available media that can be accessed by the communication device 500 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any system or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the communication device 500. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The computing device 500 includes one or more processors that read data from various entities such as memory 504 or I/O components 512. The one or more presentation components 508 present data indications to a user or other device. Exemplary presentation components include a display device, speaker, printing component, vibrating component, etc. The one or more I/O ports 510 allow the computing device 500 to be logically coupled to other devices including the one or more I/O components 512, some of which may be built in. Illustrative components include a microphone, joystick, game pad, satellite dish, scanner, printer, wireless device, etc.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation.

We claim:

1. A programmable photonic switch mode system (108) for providing real-time dynamic configurations at a white box transponder (132), the programmable photonic switch mode system (108) comprising:
a programmable photonic switch mode application (110), wherein the programmable photonic switch mode application (110) receives a plurality of user inputs (104) from an orchestrator (102); and
wherein the programmable photonic switch mode system (108) receives real-time data from an optical line system (122), wherein the programmable photonic switch mode system (108) is associated with an SDN controller, wherein the programmable photonic switch mode system (108) performs computation of run-time mode of operation.

2. The programmable photonic switch mode system (108) as claimed in claim 1, wherein at least one of:
an SDN controller (116) comprising a yang store (118) and a path computation engine (120), wherein the path computation engine (120) provides a complete path computation information to the programmable photonic switch mode system (108),
the programmable photonic switch mode system (108) comprising a network dimensioning application (114), wherein the network dimensioning application (114) provides a network dimensioning data to the programmable photonic switch mode system (108), wherein the network dimensioning data corresponds to link design, BW planning, Lambda planning,
wherein the programmable photonic switch mode system (108) computes the run-time mode of operation based on one or more of: the plurality of user inputs (104), real-time data received from the optical line system (122), the complete path computation information, and the network dimensioning data.

3. The programmable photonic switch mode system (108) as claimed in claim 1, wherein at least one of:
the programmable photonic switch mode system (108) sends the computed run time mode of operation to the white box transponder (132) for dynamically configuring the white box transponder (132),
the programmable photonic switch mode system (108) auto-tunes the white box transponder (132) with one or more device parameters, wherein the one or more device parameters comprising channel bandwidth, channel spacing, channel lambda information, channel modulation, channel power, and forward error correction (FEC) configuration, wherein the one or more device parameters comprising differential encoder (DE) configuration, current bit error ratio (BER), chromatic dispersion (CD), polarization mode dispersion (PMD) and current channel optical signal to noise ratio (OSNR).

4. The programmable photonic switch mode system (108) as claimed in claim 1, wherein at least one of:
the plurality of user inputs (104) comprising one or more parameters, wherein the one or more parameters comprising at least one of bitrate, protection type, hardware redundancy, path diversity, types of incoming traffic, maximum allowed restoration time, user service requirements and required traffic SLAs;
the plurality of user inputs (104) comprises one or more traffic profile comprising at least one of end node details, type of service, start date, end date and time of service, maximum allowed service latency, bandwidth details, priority type and service level agreement of the user;
the plurality of user inputs (104) comprising bitrate, protection type, hardware redundancy, path diversity, types of incoming traffic, and maximum allowed restoration time;
the mode of operation corresponds to a collection of photonic and optical network wide-ranging feature sets values; and
the optical line system (122) comprising ROADM (reconfigurable optical add-drop multiplexer), wavelength selective switch (WSS), multiplexing demultiplexing unit (MDU), amplifiers, variable optical attenuator (VOA) and in-line amplifier (ILA) nodes.

5. A method for providing real-time dynamic configurations at white box transponder (132) using a programmable photonic switch mode system (108), comprising:
receiving, at the programmable photonic switch mode system (108), a plurality of user inputs (104), wherein the plurality of user inputs (104) is received from an orchestrator (102);
receiving, at the programmable photonic switch mode system (108), real-time data from an optical line system (122);
computing, at the programmable photonic switch mode system (108), a run time mode of operation; and
sending, at the programmable photonic switch mode system (108), the computed run time mode of operation to the white box transponder (132), for dynamically configuring the white box transponder (132).

6. The method as claimed in claim 5, wherein the run time mode of operation are computed based on the plurality of user inputs (104), the real-time data from the optical line system (122), a complete path computation information, and a network dimensioning data with facilitation of a programmable photonic switch mode application (110)

7. The method as claimed in claim 5, wherein the complete path computation information is received from a path computation engine (120), wherein the network dimensioning data is received from a network dimensioning application (114).

8. The method as claimed in claim 5, further comprising:
receiving, at the programmable photonic switch mode system (108), a real-time frequency, power, modulation (fpm) configuration of the white box transponder (132) from at least one of: the white box transponder (132) or from a database storing fpm configuration data of the white box transponder (132).
wherein the computed mode of operation is configured to dynamically tune the white box transponder (132), based on the received real-time fpm configuration of the white box transponder (132).

9. The method as claimed in claim 5, wherein the plurality of user inputs (104) comprising at least one of:
one or more parameters, wherein the one or more parameters comprising at least one of: bitrate, protection type, hardware redundancy, path diversity, types of incoming traffic, maximum allowed restoration time, user service requirements and required traffic SLAs,
one or more traffic profile comprising at least one of: end node details, type of service, start date, end date and time of service, maximum allowed service latency, bandwidth details, priority type and service level agreement of the user, bitrate, protection type, hardware redundancy, path diversity, types of incoming traffic, and maximum allowed restoration time.

10. The method as claimed in claim 5, wherein at least one of:
the run-time mode of operation corresponds to a collection of photonic and optical network wide-ranging feature sets values,
the network dimensioning data corresponds to link design, BW planning, Lambda planning,
the optical line system (122) comprising ROADM (reconfigurable optical add-drop multiplexer) (134, 136), wavelength selective switch (WSS), multiplexing demultiplexing unit (MDU), amplifiers, variable optical attenuator (VOA) and in-line amplifier (ILA) nodes.

11. The method as claimed in claim 5, wherein the method performs switching of the mode of operation during run-time, based on change in at least one of:
the plurality of user inputs (104), the real-time data from the optical line system (122), the complete path computation information, the network dimensioning data, and fpm configuration of the white box transponder (132).

12. The method as claimed in claim 5, wherein the white box transponder (132) is auto-tuned with one or more device parameters, wherein the one or more device parameters comprising channel bandwidth, channel spacing, channel lambda information, channel modulation, channel power, and forward error correction (FEC) configuration, wherein the one or more device parameters comprising differential encoder (DE) configuration, current bit error ratio (BER), chromatic dispersion (CD), polarization mode dispersion (PMD) and current channel optical signal to noise ratio (OSNR).

13. The method as claimed in claim 5, further comprising:
providing a plurality of read only (RO) optical parameters with toggling range from to a QoTd script running at the transponder (132),
wherein the QoTd script enables dynamic configuration of the white box transponder (132) and the optical network feature set as per the plurality of read only (RO) optical parameters.
